(19) United States
(12) Patent Application Publication
(10) Pub. No.: US 2024/0428264 A1
(43) Pub. Date: Dec. 26, 2024

(54) PRODUCTION MANAGEMENT DEVICE, DISPLAY DEVICE, AND PRODUCTION DEVICE

(71) Applicant: SUMITOMO HEAVY INDUSTRIES, LTD., Tokyo (JP)

(72) Inventor: Tomosuke KADOONO, Chiba (JP)

(21) Appl. No.: 18/675,576

(22) Filed: May 28, 2024

(30) Foreign Application Priority Data
Jun. 22, 2023 (JP) 2023-102692

(51) Int. Cl. G06Q 30/018

(52) U.S. Cl. CPC G06Q 30/018

(57) ABSTRACT

A production management device includes circuitry configured to acquire information indicating an emission amount of carbon dioxide corresponding to an amount of electric power supplied from each of one or more power generation facilities owned by an electric utility company having a contract for supplying electric power to a production device and a power generation facility for in-house power generation; acquire information indicating a ratio of the amount of electric power supplied from a corresponding one of the power generation facilities for the production device to produce a product; and calculate an emission amount of carbon dioxide generated by the production of the product, based on an amount of electric power used for the production of the product, the ratios of the amounts of electric power, and emission amounts of carbon dioxide corresponding to the amounts of electric power generated by one or more of the power generation facilities.

### CROSS-REFERENCE TO RELATED APPLICATION

This application is based upon and claims priority to Japanese Patent Application No. 2023-102692, filed on Jun. 22, 2023, the entire contents of which are incorporated herein by reference.

### BACKGROUND

### 1. Technical Field

The present disclosure relates to a production management device, a display device, and a production device.

### 2. Description of Related Art

Generally, producing products by production devices tends to require consideration of production costs and other factors. For example, in order to reduce electric power demand, a technique has been proposed in which an operation mode is provided to change the supply source of electric power to drive respective devices of an injection molding machine.

### SUMMARY

According to one embodiment of the present disclosure, a production management device includes
circuitry configured to
   acquire information indicating an emission amount of carbon dioxide corresponding to an amount of electric power supplied from each of one or more of power generation facilities, among power generation facilities owned by an electric utility company that has a contract for supplying electric power to a production device and a power generation facility provided for in-house power generation;
   acquire information indicating a ratio of the amount of electric power supplied from a corresponding one of the one or more of the power generation facilities for the production device to produce a product; and
   calculate an emission amount of carbon dioxide generated by the production of the product, based on an amount of electric power used for the production of the product, the ratios of the amounts of electric power supplied from the one or more of the power generation facilities, and emission amounts of carbon dioxide corresponding to the amounts of electric power generated by the one or more of the power generation facilities.

### BRIEF DESCRIPTION OF THE DRAWINGS

FIG. 1 is a view illustrating a state of an injection molding machine according to an embodiment at the time of completion of mold opening.

FIG. 2 is a view illustrating a state of the injection molding machine according to the embodiment at the time of mold clamping.

FIG. 3 is a conceptual diagram illustrating a relationship between a production company having an injection molding machine and an electric utility company for supplying electric power according to an embodiment.

FIG. 4 is a functional block diagram illustrating components of a control device of the injection molding machine according to the embodiment.

FIG. 5 is a diagram illustrating a power generation facility setting screen output by a display control unit according to the embodiment.

FIG. 6 is a diagram illustrating a log information screen output by the display control unit according to the embodiment.

FIG. 7 is a diagram illustrating a power consumption display screen output by the display control unit according to the embodiment.

FIG. 8 is a conceptual diagram illustrating a relationship between a production company having a production device and an electric utility company for supplying electric power, according to another embodiment.

### DETAILED DESCRIPTION

In the recent related art technique; however, in addition to the consideration of the production costs and the like, consideration of environmental measures with the goal of achieving a sustainable society has been required. For example, in manufacturing industries, as a countermeasure against global warming, it is required to visualize an emission amount of carbon dioxide generated in the production of products and to announce that efforts are being made to achieve a low-carbon society.

In this case, it is preferable to calculate the emission amount of carbon dioxide by using a specific technique corresponding to a power generation technique of an electric utility company or a facility provided for in-house power generation, instead of using a general method. That is, in electric utility companies or in-house power generation facilities, efforts are made to reduce the emission amount of carbon dioxide in order to achieve a low-carbon society. Therefore, it is required that the emission amount of carbon dioxides generated in the production of products be visualized in consideration of the efforts of companies such as electric utility companies and facility manufacturers.

According to at least one embodiment of the present disclosure, a technique is provided for grasping a situation relating to the production of a product by calculating an emission amount of carbon dioxide generated by the production of the product in consideration of an emission amount of carbon dioxide generated by power generation of one or more of power generation facilities owned by an electric utility company and a power generation facility provided for in-house power generation.

According to the above embodiment, it is desirable to provide a technique for grasping a situation relating to production of a product by calculating an emission amount of carbon dioxide generated by the production of the product.

Hereinafter, embodiments of the present disclosure will be described with reference to the accompanying drawings. The embodiments described below are not intended to limit the invention but are merely examples, and all features and combinations thereof described in the embodiments are not necessarily essential to the invention. In the drawings, the same or corresponding components are denoted by the same or corresponding reference numerals, and the description thereof may be omitted.

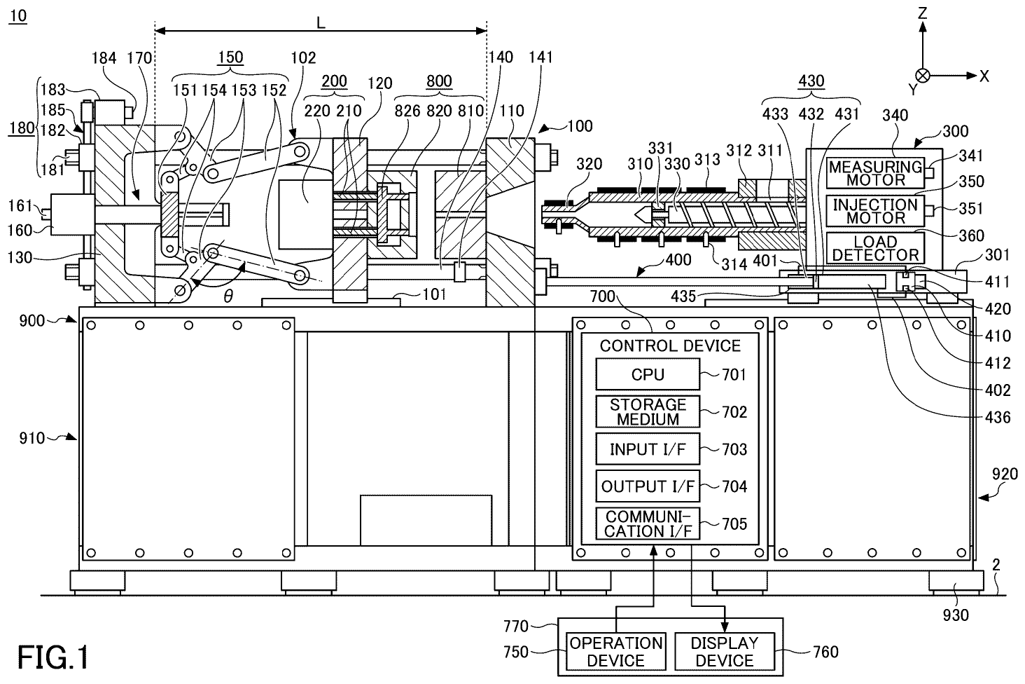

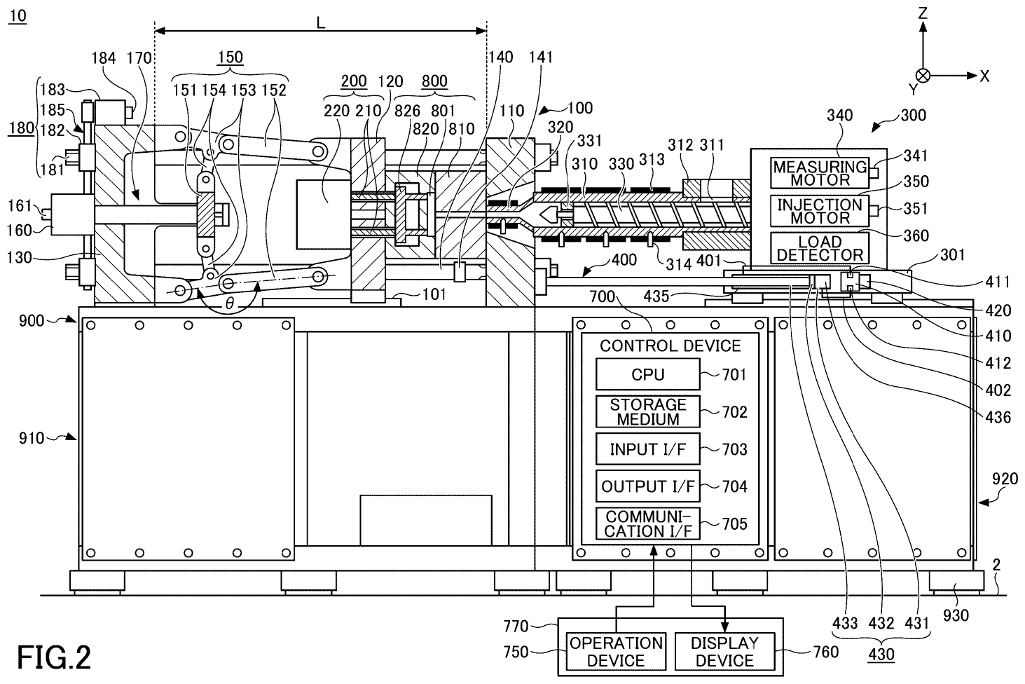

FIG. 1 is a view illustrating a state of an injection molding machine according to an embodiment at the time of completion of mold opening. FIG. 2 is a view illustrating a state of the injection molding machine according to the embodiment at the time of mold clamping. In the present specification, an X-axis direction, a Y-axis direction, and a Z-axis direction are directions perpendicular to each other. The X-axis direction and the Y-axis direction represent a horizontal direction, and the Z-axis direction represents a vertical direction. When a mold clamping device 100 is a horizontal type, the X-axis direction is a mold opening/closing direction, and the Y-axis direction is a width direction of an injection molding machine 10. The negative side in the Y-axis direction is called an operating side, and the positive side in the Y-axis direction is called a non-operating side.

As illustrated in FIGS. 1 and 2, the injection molding machine 10 includes the mold clamping device 100 that opens and closes a mold device 800, an ejector device 200 that ejects a molded article molded by the mold device 800, an injection device 300 that injects a molding material into the mold device 800, a moving device 400 that moves the injection device 300 back and forth with respect to the mold device 800, a control device 700 that controls each component of the injection molding machine 10, and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are each installed on the floor 2 via leveling adjusters 930. The control device 700 is disposed in the internal space of the injection device frame 920. Hereinafter, each component of the injection molding machine 10 will be described.

### Mold Clamping Device

In the description of the mold clamping device 100, a moving direction (e.g., an X-axis positive direction) of a movable platen 120 at the time of mold closing is referred to as a front side, and a moving direction (e.g., an X-axis negative direction) of the movable platen 120 at the time of mold opening is referred to as a rear side.

The mold clamping device 100 performs mold closing, pressurizing, mold clamping, depressurizing, and mold opening of the mold device 800. The mold device 800 includes a fixed mold 810 and a movable mold 820. The mold clamping device 100 is, for example, a horizontal type, and the mold opening/closing direction is a horizontal direction. The mold clamping device 100 includes a fixed platen 110 to which the fixed mold 810 is attached, a movable platen 120 to which the movable mold 820 is attached, and a moving mechanism 102 that moves the movable platen 120 in a mold opening/closing direction with respect to the fixed platen 110.

The fixed platen 110 is fixed to the mold clamping device frame 910. The fixed mold 810 is attached to a surface of the fixed platen 110 facing the movable platen 120.

The movable platen 120 is disposed so as to be movable in the mold opening/closing direction with respect to the mold clamping device frame 910. A guide 101 for guiding the movable platen 120 is laid on the mold clamping device frame 910. The movable mold 820 is attached to a surface of the movable platen 120 facing the fixed platen 110.

The moving mechanism 102 moves the movable platen 120 back and forth with respect to the fixed platen 110 to perform mold closing, pressurizing, mold clamping, depressurizing, and mold opening of the mold device 800. The moving mechanism 102 includes a toggle support 130 disposed at a distance from the fixed platen 110, a tie bar 140 connecting the fixed platen 110 and the toggle support 130, a toggle mechanism 150 moving the movable platen 120 in the mold opening/closing direction with respect to the toggle support 130, a mold clamping motor 160 operating the toggle mechanism 150, a motion conversion mechanism 170 converting a rotational motion of the mold clamping motor 160 into linear motion, and a mold thickness adjustment mechanism 180 adjusting the distance between the fixed platen 110 and the toggle support 130.

The toggle support 130 is disposed with a space from the fixed platen 110 and is placed on the mold clamping device frame 910 so as to be movable in the mold opening/closing direction. The toggle support 130 may be disposed so as to be movable along a guide laid on the mold clamping device frame 910. The guide of the toggle support 130 may be common to the guide 101 of the movable platen 120.

In the present embodiment, the fixed platen 110 is fixed to the mold clamping device frame 910, and the toggle support 130 is disposed so as to be movable in the mold opening/closing direction with respect to the mold clamping device frame 910, but the toggle support 130 may be fixed to the mold clamping device frame 910, and the fixed platen 110 may be disposed so as to be movable in the mold opening/closing direction with respect to the mold clamping device frame 910.

The tie bar 140 connects the fixed platen 110 and the toggle support 130 with an interval L in the mold opening/closing direction. A plurality of (e.g., four) tie bars 140 may be used. The plurality of tie bars 140 are disposed in parallel in the mold opening/closing direction and extend according to the mold clamping force. A tie bar strain detector 141 for detecting strain of the tie bar 140 may be provided on at least one tie bar 140. The tie bar strain detector 141 sends a signal indicating a detection result to the control device 700. The detection result of the tie bar strain detector 141 is used for detection of the mold clamping force and the like.

In the present embodiment, the tie bar strain detector 141 is used as a mold clamping force detector that detects the mold clamping force, but the configuration of the present embodiment of the present disclosure is not limited to this example. The mold clamping force detector is not limited to a strain gauge type, and may be a piezoelectric type, a capacitance type, a hydraulic type, an electromagnetic type, or the like, and the position to which the mold clamping force detector is attached is not limited to the tie bar 140.

The toggle mechanism 150 is disposed between the movable platen 120 and the toggle support 130, and moves the movable platen 120 in the mold opening/closing direction with respect to the toggle support 130. The toggle mechanism 150 includes a crosshead 151 that moves in the mold opening/closing direction, and a pair of link groups that extend or contract by the movement of the crosshead 151. The pair of link groups each include a first link 152 and a second link 153 which are connected to each other by a pin or the like so as to be extendable and contractible. The first link 152 is attached to the movable platen 120 by a pin or the like so as to be swingable. The second link 153 is swingably attached to the toggle support 130 by a pin or the like. The second link 153 is attached to the crosshead 151 via a third link 154. When the crosshead 151 is moved back and forth with respect to the toggle support 130, the first link 152 and the second link 153 are extended or contracted, and the movable platen 120 is moved back and forth with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. The mold clamping motor 160 moves the crosshead 151 back and forth with respect to the toggle support 130 to extend or contract the first link 152 and the second link 153, and moves the movable platen 120 back and forth with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotational motion of the mold clamping motor 160 into a linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing process, a pressurizing process, a mold clamping process, a depressurizing process, a mold opening process, and the like under the control of the control device 700.

In the mold closing process, the mold clamping motor 160 is driven to advance the crosshead 151 to a mold closing completion position at a set moving speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating a detection result to the control device 700.

The crosshead position detector that detects the position of the crosshead 151 and the crosshead moving speed detector that detects the moving speed of the crosshead 151 are not limited to the mold clamping motor encoder 161, and a general detector may be used. Further, the movable platen position detector for detecting the position of the movable platen 120 and the movable platen moving speed detector for detecting the moving speed of the movable platen 120 are not limited to the mold clamping motor encoder 161, and a general detector may be used.

In the pressurizing process, the mold clamping force is generated by further driving the mold clamping motor 160 to further advance the crosshead 151 from the mold closing completion position to a mold clamping position.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (see FIG. 2) is formed between the movable mold 820 and the fixed mold 810, and the injection device 300 fills the cavity space 801 with a liquid molding material. The filled molding material is solidified to obtain a molded article.

The number of cavity spaces 801 may be one or more. In the latter case, a plurality of molded articles are obtained simultaneously. An insert material may be disposed in a part of the cavity space 801, and a molding material may be filled in another part of the cavity space 801. A molded article is obtained by integrating the insert material and the molding material.

In the depressurizing process, the mold clamping motor 160 is driven to retract the crosshead 151 from the clamping position to the mold opening start position, thereby retracting the movable platen 120 and reducing the clamping force. The mold opening start position and the mold closing completion position may be the same position.

In the mold opening process, the mold clamping motor 160 is driven to retract the crosshead 151 from the mold opening start position to the mold opening completion position at the set moving speed, thereby retracting the movable platen 120 and separating the movable mold 820 from the fixed mold 810. Thereafter, the ejector device 200 ejects the molded article from the movable mold 820.

The setting conditions in the mold closing process, the pressurizing process, and the mold clamping process are collectively set as a series of setting conditions. For example, the moving speed and position (including a mold closing start position, a moving speed switching position, the mold closing completion position, and mold clamping position) of the crosshead 151 in the mold closing process and the pressurizing process, and the mold clamping force are collectively set as a series of setting conditions. The mold closing start position, the moving speed switching position, the mold closing completion position, and the mold clamping position are disposed in this order from the rear side to the front side, and represent a start point and an end point of a section in which the moving speed is set. A moving speed is set for each section. The number of moving speed switching positions may be one or more. The moving speed switching position may not be set. Only one of the mold clamping position and the mold clamping force may be set.

The setting conditions in the depressurizing process and the mold opening process are set in the same manner. For example, the moving speed and position (the mold opening start position, the moving speed switching position, and the mold opening completion position) of the crosshead 151 in the depressurizing process and the mold opening process are collectively set as a series of setting conditions. The mold opening start position, the moving speed switching position, and the mold opening completion position are disposed in this order from the front side to the rear side, and represent a start point and an end point of a section in which the moving speed is set. A moving speed is set for each section. The number of the moving speed switching positions may be one or more. The moving speed switching position may not be set. The mold opening start position and the mold closing completion position may be the same position. The mold opening completion position and the

mold closing start position may be the same position. Instead of the moving speed and the position of the crosshead 151, the moving speed and the position of the movable platen 120 may be set. Further, instead of the position of the crosshead (e.g., the mold clamping position) or the position of the movable platen, the mold clamping force may be set.

The toggle mechanism 150 amplifies the driving force of the mold clamping motor 160 and transmits the amplified driving force to the movable platen 120. The amplification factor is also called a toggle factor. The toggle magnification changes according to an angle θ formed by the first link 152 and the second link 153 (hereinafter, also referred to as a “link angle θ”). The link angle θ is obtained from the position of the crosshead 151. When the link angle θ is 180°, the toggle magnification is maximized.

When the thickness of the mold device 800 changes due to the replacement of the mold device 800 or the temperature change of the mold device 800, the mold thickness is adjusted such that a predetermined mold clamping force is obtained at the time of mold clamping. In the mold thickness adjustment, for example, the interval L between the fixed platen 110 and the toggle support 130 is adjusted such that the link angle θ of the toggle mechanism 150 becomes a predetermined angle at the time of mold touch when the movable mold 820 touches the fixed mold 810.

The mold clamping device 100 includes the mold thickness adjustment mechanism 180. The mold thickness adjustment mechanism 180 adjusts the mold thickness by adjusting the interval L between the fixed platen 110 and the toggle support 130. The thickness adjustment is performed, for example, between the end of a molding cycle and the start of the next molding cycle. The mold thickness adjustment mechanism 180 includes, for example, a screw shaft 181 formed at the rear end portion of the tie bar 140, a screw nut 182 held by the toggle support 130 so as to be rotatable and not to be movable back and forth, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to the plurality of screw nuts 182 via the rotational driving force transmission unit 185. The plurality of screw nuts 182 can be rotated synchronously. Note that the plurality of screw nuts 182 can be individually rotated by changing a transmission path of the rotational driving force transmission unit 185.

The rotational driving force transmission unit 185 is configured by, for example, gears and the like. In this case, a driven gear is formed on the outer periphery of each screw nut 182, a driving gear is attached to the output shaft of the mold thickness adjustment motor 183, and an intermediate gear, which meshes with the plurality of driven gears and the driving gear, is rotatably held at the center of the toggle support 130. The rotational driving force transmission unit 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the interval L between the fixed platen 110 and the toggle support 130 is adjusted. A plurality of mold thickness adjustment mechanisms may be used in combination.

The interval L is detected by using the mold thickness adjustment motor encoder 184. The mold thickness adjustment motor encoder 184 detects the rotation amount and the rotation direction of the mold thickness adjustment motor 183, and sends a signal indicating a detection result to the control device 700. The detection result of the mold thickness adjustment motor encoder 184 is used for monitoring and controlling the position of the toggle support 130 and the interval L. The toggle support position detector for detecting the position of the toggle support 130 and the interval detector for detecting the interval L are not limited to the mold thickness adjustment motor encoder 184, and a general detector may be used.

The mold clamping device 100 may include a mold temperature regulator that regulates the temperature of the mold device 800. The mold device 800 has a flow path for a temperature control medium therein. The mold temperature regulator regulates the temperature of the mold device 800 by regulating the temperature of the temperature regulating medium supplied to the flow path of the mold device 800.

The mold clamping device 100 of the present embodiment is a horizontal type in which the mold opening/closing direction is a horizontal direction, but may be a vertical type in which the mold opening/closing direction is a vertical direction.

The mold clamping device 100 of the present embodiment includes the mold clamping motor 160 as a drive source, but may include a hydraulic cylinder instead of the mold clamping motor 160. The mold clamping device 100 may include a linear motor for opening and closing the mold and an electromagnet for clamping the mold.

### Ejector Device

In the description of the ejector device 200, as in the description of the mold clamping device 100, the moving direction (e.g., the X-axis positive direction) of the movable platen 120 at the time of mold closing is described as the front, and the moving direction (e.g., the X-axis negative direction) of the movable platen 120 at the time of mold opening is described as the rear side.

The ejector device 200 is attached to the movable platen 120 and moves back and forth together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 in a retractable manner. The front end portion of the ejector rod 210 is in contact with an ejector plate 826 of the movable mold 820. The front end portion of the ejector rod 210 may be connected to the ejector plate 826 or may not be connected to the ejector plate 826.

The drive mechanism 220 includes, for example, an ejector motor, and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs an ejection process under the control of the control device 700. In the ejection process, the ejector rod 210 is moved forward from the standby position to the ejection position at a set moving speed, whereby the ejector plate 826 is moved forward to eject the molded article. Thereafter, the ejector motor is driven to move the ejector rod 210 backward at a set moving speed, and the ejector plate 826 is moved backward to the original standby position.

The position and the moving speed of the ejector rod 210 are detected by using, for example, an ejector motor encoder. The ejector motor encoder detects the rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and a general detector may be used.

### Injection Device

In the description of the injection device 300, unlike the description of the mold clamping device 100 and the description of the ejector device 200, the moving direction of the screw 330 during filling (e.g., the X-axis negative direction) is referred to as the front, and the moving direction of the screw 330 during measurement (e.g., the X-axis positive direction) is referred to as the rear side.

The injection device 300 is installed on a slide base 301, and the slide base 301 is disposed in a retractable manner with respect to an injection device frame 920. The injection device 300 is disposed in a retractable manner with respect to the mold device 800. The injection device 300 touches the mold device 800 and fills the cavity space 801 in the mold device 800 with the molding material measured in a cylinder 310. The injection device 300 includes, for example, the cylinder 310 that heats the molding material, a nozzle 320 provided at a front end portion of the cylinder 310, a screw 330 disposed in the cylinder 310 in a rotatable and retractable manner, a measuring motor 340 that rotates the screw 330, an injection motor 350 that moves the screw 330 back and forth, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312 such as a water-cooled cylinder is provided on the outer periphery of the rear portion of the cylinder 310. A heater 313 such as a band heater and a temperature detector 314 are provided on the outer periphery of the cylinder 310 in front of the cooler 312.

The cylinder 310 is divided into a plurality of zones in the axial direction (e.g., the X-axis direction) of the cylinder 310. The heater 313 and the temperature detector 314 are provided in each of the plurality of zones. A set temperature is set for each of the plurality of zones, and the control device 700 controls the heater 313 such that the temperature detected by the temperature detector 314 becomes the set temperature.

The nozzle 320 is provided at the front end portion of the cylinder 310 and is pressed against the mold device 800. The heater 313 and the temperature detector 314 are provided on the outer periphery of the nozzle 320. The control device 700 controls the heater 313 such that the detected temperature of the nozzle 320 becomes the set temperature.

The screw 330 is disposed in the cylinder 310 in a rotatable and retractable manner. When the screw 330 is rotated, the molding material is fed forward along spiral grooves of the screw 330. The molding material is gradually melted by the heat from the cylinder 310 while being fed forward. As the liquid molding material is fed to the front side of the screw 330 and accumulated in the front portion of the cylinder 310, the screw 330 is moved backward. Thereafter, when the screw 330 is advanced, the liquid molding material accumulated in front of the screw 330 is injected from the nozzle 320 and is filled into the mold device 800.

A backflow prevention ring 331 is attached to the front side of the screw 330 in a retractable manner as a backflow prevention valve that prevents backflow of the molding material from the front side to the rear side of the screw 330 when the screw 330 is pushed forward.

When the screw 330 is advanced, the backflow prevention ring 331 is pushed rearward by the pressure of the molding material in front of the screw 330, and is retracted relative to the screw 330 to a closing position (see FIG. 2) at which the backflow prevention ring 331 closes the flow path of the molding material. This prevents the molding material accumulated in front of the screw 330 from flowing backward.

On the other hand, when the screw 330 is rotated, the backflow prevention ring 331 is pushed forward by the pressure of the molding material fed forward along the spiral grooves of the screw 330, and moves forward relative to the screw 330 to an open position (see FIG. 1) at which the flow path of the molding material is opened. Thus, the molding material is fed to the front side of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 back and forth between the open position and the closed position with respect to the screw 330.

The measuring motor 340 rotates the screw 330. The drive source for rotating the screw 330 is not limited to the measuring motor 340, and may be, for example, a hydraulic pump.

The injection motor 350 moves the screw 330 back and forth. A motion conversion mechanism or the like for converting the rotational motion of the injection motor 350 into the linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and the molding material, and is used for controlling or monitoring a pressure received by the screw 330 from the molding material, a back pressure to the screw 330, a pressure acting on the molding material from the screw 330, and the like.

The pressure detector for detecting the pressure of the molding material is not limited to the load detector 360, and a general pressure detector may be used. For example, a nozzle pressure sensor or a mold internal pressure sensor may be used. The nozzle pressure sensor is installed in the nozzle 320. The mold internal pressure sensor is installed inside the mold device 800.

The injection device 300 performs a measuring process, a filling process, a pressure holding process, and the like under the control of the control device 700. The filling process and the pressure holding process may be collectively referred to as an injection process.

In the measuring process, the measuring motor 340 is driven to rotate the screw 330 at a set rotation speed, and the molding material is fed forward along the spiral grooves of the screw 330. Accordingly, the molding material is gradually melted. As the liquid molding material is fed to the front side of the screw 330 and accumulated in the front portion of the cylinder 310, the screw 330 is moved backward. The rotation speed of the screw 330 is detected by using, for example, the measuring motor encoder 341. The measuring motor encoder 341 detects the rotation of the measuring motor 340 and sends a signal indicating the detection result to the control device 700. The screw rotational speed detector for detecting the rotational speed of the screw 330 is not limited to the measuring motor encoder 341, and a general detector may be used.

In the measuring process, in order to limit the rapid retraction of the screw 330, the injection motor 350 may be driven to apply a predetermined back pressure to the screw 330. The back pressure to the screw 330 is detected by using, for example, the load detector 360. When the screw 330 retracts to the measuring completion position and a predetermined amount of the molding material is accumulated in front of the screw 330, the measuring process is completed.

The position and the rotation speed of the screw 330 in the measuring process are collectively set as a series of setting conditions. For example, a measurement start position, a rotational speed switching position, and a measurement completion position are set. These positions are disposed in this order from the front side to the rear side, and represent the start point and the end point of the section in which the rotation speed is set. The rotation speed is set for each section. The rotational speed switching position may be one or more. The rotational speed switching position may not be set. Further, the back pressure is set for each section.

In the filling process, the injection motor 350 is driven to move the screw 330 forward at a set moving speed, and the liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350, and sends a signal indicating the detection result to the control device 700.

When the position of the screw 330 reaches the set position, switching from the filling process to the pressure holding process (so-called “V/P switching”) is performed. The position where the V/P switching is performed is also referred to as a V/P switching position. The set moving speed of the screw 330 may be changed according to the position of the screw 330, time, or the like.

The position and the moving speed of the screw 330 in the filling process are collectively set as a series of setting conditions. For example, the filling start position (also referred to as “injection start position”) is set. The moving speed switching position and the V/P switching position are set. These positions are disposed in this order from the rear side to the front side and represent the start point and the end point of the section in which the moving speed is set. A moving speed is set for each section. The number of the moving speed switching positions may be one or more. The moving speed switching position may not be set.

The upper limit value of the pressure of the screw 330 is set for each section in which the moving speed of the screw 330 is set. The pressure of the screw 330 is detected by the load detector 360. When the pressure of the screw 330 is equal to or lower than the set pressure, the screw 330 is moved forward at the set moving speed. On the other hand, when the pressure of the screw 330 exceeds the set pressure, the screw 330 is advanced at a moving speed lower than the set moving speed such that the pressure of the screw 330 becomes equal to or lower than the set pressure for the purpose of protecting the mold.

Note that, after the position of the screw 330 reaches the V/P switching position in the filling process, the screw 330 may be temporarily stopped at the V/P switching position, and then the V/P switching may be performed. Immediately before the V/P switching, the screw 330 may be advanced or retracted at a very low speed instead of stopping the screw 330. Further, the screw position detector for detecting the position of the screw 330 and the screw moving speed detector for detecting the moving speed of the screw 330 are not limited to the injection motor encoder 351, and a general detector may be used.

In the pressure holding process, the injection motor 350 is driven to push the screw 330 forward, and the pressure of the molding material at the front end portion of the screw 330 (hereinafter, also referred to as “holding pressure”) is increased. The molding material remaining in the cylinder 310 is pushed toward the mold device 800. The molding material can be replenished to compensate shortages caused by the cooling shrinkage in the mold device 800. The holding pressure is detected by using, for example, the load detector 360. The set value of the holding pressure may be changed according to the elapsed time from the start of the pressure holding process. A plurality of holding pressures and a plurality of holding times for holding the holding pressures in the pressure holding process may be set, and may be collectively set as a series of setting conditions.

In the pressure holding process, the molding material in the cavity space 801 in the mold device 800 is gradually cooled, and when the pressure holding process is completed, the inlet of the cavity space 801 is closed by the solidified molding material. This state is called a gate seal, and the backflow of the molding material from the cavity space 801 is prevented. After the pressure holding process, the cooling process is started. In the cooling process, the molding material in the cavity space 801 is solidified. In order to shorten the molding cycle time, the measuring process may be performed during the cooling process.

The injection device 300 of the present embodiment is of an in-line screw type, but may be of a pre-plasticizing type or the like. The pre-plasticizing injection device supplies a molding material melted in a plasticizing cylinder to an injection cylinder, and injects the molding material from the injection cylinder into the mold device. In the plasticizing cylinder, a screw is disposed in a rotatable and non-retractable manner, or a screw is disposed in a rotatable and retractable manner. On the other hand, a plunger is disposed in the injection cylinder in a retractable manner.

Further, the injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the horizontal injection device 300 may be a horizontal type or a vertical type.

### Moving Device

In the description of the moving device 400, as in the description of the injection device 300, the moving direction (e.g., the X-axis negative direction) of the screw 330 during filling is referred to as the front side, and the moving direction (e.g., the X-axis positive direction) of the screw 330 during measurement is referred to as the rear side.

The moving device 400 moves the injection device 300 back and forth with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions. The hydraulic pump 410 generates a hydraulic pressure by switching the rotation direction of the motor 420 to suck a working fluid (e.g., oil) from one of the first port 411 and the second port 412 and discharge the working fluid from the other. The hydraulic pump 410 can also suck the working fluid from a tank and discharge the working fluid from either one of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the interior of the cylinder main body 431 into a front chamber 435 as a first chamber and a rear chamber 436 as a second chamber. The piston rod 433 is fixed relative to the fixed platen 110.

The front chamber 435 of the hydraulic cylinder 430 is connected to the first port 411 of the hydraulic pump 410 via a first flow path 401. The working fluid discharged from the first port 411 is supplied to the front chamber 435 via the first flow path 401, whereby the injection device 300 is pushed forward. The injection device 300 is advanced, and the nozzle 320 is pressed against the fixed mold 810. The front chamber 435 functions as a pressure chamber that generates a nozzle touch pressure of the nozzle 320 by the pressure of the working liquid supplied from the hydraulic pump 410.

On the other hand, the rear chamber 436 of the hydraulic cylinder 430 is connected to the second port 412 of the hydraulic pump 410 via the second flow path 402. The hydraulic fluid discharged from the second port 412 is supplied to the rear chamber 436 of the hydraulic cylinder 430 via the second flow path 402, whereby the injection device 300 is pushed rearward. The injection device 300 is retracted, and the nozzle 320 is separated from the fixed mold 810.

In the present embodiment, the moving device 400 includes the hydraulic cylinder 430, but the configuration of the present disclosure is not limited to this example.

For example, instead of the hydraulic cylinder 430, an electric motor and a motion conversion mechanism that converts the rotational motion of the electric motor into the linear motion of the injection device 300 may be used.

### Control Device

The control device 700 is configured by, for example, a computer, and includes circuitry including a central processing unit (CPU) 701, a storage medium 702 such as a memory, an input interface (I/F) 703, an output interface (I/F) 704, and a communication interface (I/F) 705 as illustrated in FIGS. 1 and 2. The control device 700 performs various controls by causing the CPU 701 to execute a program stored in the storage medium 702. The control device 700 receives a signal from the outside through the input I/F 703 and transmits a signal to the outside through the output I/F 704. The control device 700 transmits information to an external device via the communication I/F 705.

The control device 700 repeatedly performs the measuring process, the mold closing process, the pressurizing process, the mold clamping process, the filling process, the pressure holding process, the cooling process, the depressurizing process, the mold opening process, the ejection process, and the like, and thus repeatedly produces a molded article. A series of operations for obtaining a molded article, for example, an operation from the start of a measuring process to the start of the next measuring process is also referred to as a “shot” or a “molding cycle”. The time required for one shot is also referred to as “molding cycle time” or “cycle time”.

One molding cycle includes, for example, a measuring process, a mold closing process, a pressurizing process, a mold clamping process, a filling process, a pressure holding process, a cooling process, a depressurizing process, a mold opening process, and an ejection process in this order. The order here is the order of the start of each process. The filling process, the pressure holding process, and the cooling process are performed during the mold clamping process. The start of the mold clamping process may match the start of the filling process. The completion of the depressurizing process matches the start of the mold opening process.

A plurality of processes may be performed simultaneously for the purpose of shortening the molding cycle time. For example, the measuring process may be performed during the cooling process of a previous molding cycle, or may be performed during the mold clamping process. In this case, the mold closing process may be performed at the beginning of the molding cycle. The filling process may be started during the mold closing process. The ejection process may be started during the mold opening process. In a case where an opening/closing valve that opens and closes the flow path of the nozzle 320 is provided, the mold opening process may be started during the measuring process. This is because even if the mold opening process is started during the measuring process, the molding material does not leak from the nozzle 320 as long as the opening/closing valve closes the flow path of the nozzle 320.

One molding cycle may include a process other than the measuring process, the mold closing process, the pressurizing process, the mold clamping process, the filling process, the pressure holding process, the cooling process, the depressurizing process, the mold opening process, and the ejection process.

For example, after the completion of the pressure holding process and before the start of the measuring process, a pre-measuring suck-back process of retracting the screw 330 to a preset measuring start position may be performed. This can reduce the pressure of the molding material accumulated in front of the screw 330 before the start of the measuring process, and can prevent the rapid retraction of the screw 330 at the start of the measuring process.

After the completion of the measuring process and before the start of the filling process, a post-measuring suck-back process of retracting the screw 330 to a preset filling start position (also referred to as an “injection start position”) may be performed. This can reduce pressure of the molding material accumulated in front of the screw 330 before the start of the filling process, and can prevent the leakage of the molding material from the nozzle 320 before the start of the filling process.

The control device 700 is connected to an operation device 750 that receives an input operation by an operator and a display device 760 that displays a screen. The operation device 750 and the display device 760 may be configured by, for example, a touch panel 770 and may be integrated. The touch panel 770 as the display device 760 displays a screen under the control of the control device 700. For example, the display device 760 may include a liquid crystal panel (an example of a display unit) for displaying a screen. The display unit is not limited to the liquid crystal panel, and another display device such as an organic EL may be used. For example, information such as the setting of the injection molding machine 10 and the current state of the injection molding machine 10 may be displayed on the screen of the touch panel 770. The touch panel 770 can receive an operation in a displayed screen area. In addition, for example, an operation unit such as a button or an input field for receiving an input operation by an operator may be displayed in the screen area of the touch panel 770. The touch panel 770 as the operation device 750 detects an input operation on the screen by the operator and outputs a signal corresponding to the input operation to the control device 700. Thus, for example, the operator can perform setting (including input of a setting value) of the injection molding machine 10 by operating the operation unit provided on the screen while checking the information displayed on the screen. Further, the operator can operate the operation unit provided on the screen to cause the injection molding machine 10 to perform an operation corresponding to the operation unit. Note that the operation of the injection molding machine 10 may be, for example, the operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided independently. A plurality of operation devices 750 may be provided. The operation device 750 and the display device 760 are disposed on the operation side (Y-axis negative direction) of the mold clamping device 100 (more specifically, the fixed platen 110).

### Embodiment

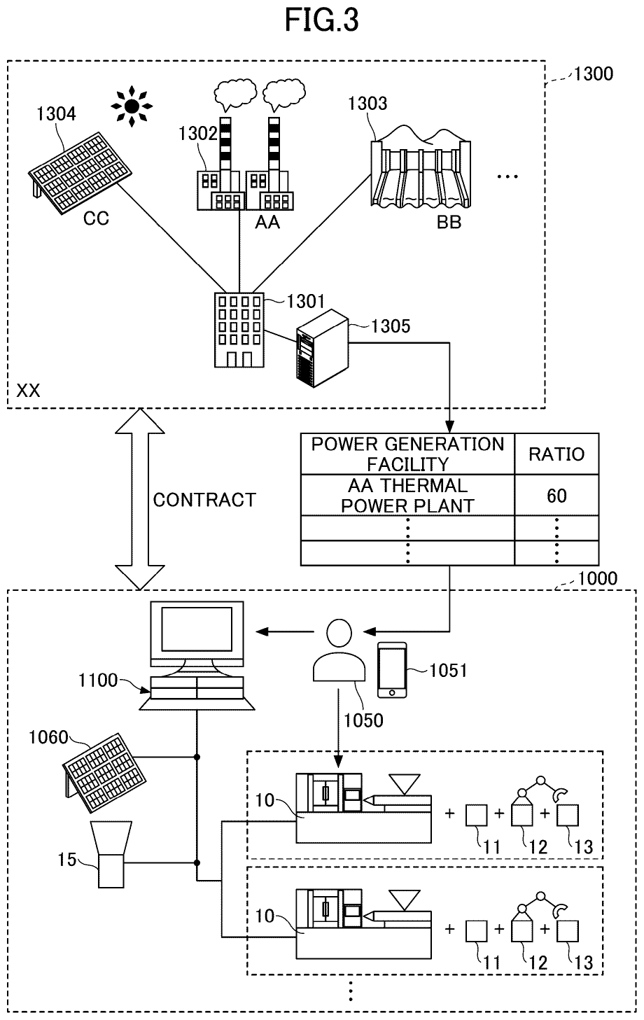

Next, a relationship between a production company having a production device and an electric utility company supplying electric power will be described. FIG. 3 is a conceptual diagram illustrating a relationship between a production company 1000 having the injection molding machine 10 and an electric utility company 1300 for supplying electric power according to the present embodiment. In the example illustrated in FIG. 3, an example in which the production company owns an injection molding machine 10 as the production device will be described.

In the present embodiment, the production company 1000 has a contract with the electric utility company 1300, and thus can receive the supply of electric power from the electric utility company 1300. In the present embodiment, an example in which the electric utility company 1300 is referred to as XX Electric Power Corporation and is responsible for providing services from power generation to power transmission and retail sales will be described. However, the present embodiment is not limited to this configuration, and the power generation, the power transmission, and the retail may be separate companies as long as the production company 1000 can grasp the information on the power generation.

In the present embodiment, a case where the production company 1000 has a contract with the electric utility company 1300 will be described, but the production company 1000 may have contracts with a plurality of electric utility companies in order to receive supply of electric power.

As illustrated in FIG. 3, the electric utility company 1300 includes a head office 1301, an AA thermal power plant 1302, a BB hydroelectric power plant 1303, and a CC photovoltaic power plant 1304. In the present embodiment, examples of the power generation facilities supplied by the electric utility company 1300 are illustrated, and other power generation facilities such as an electronic power generation facility or a geothermal power generation facility may be used.

The head office 1301 is communicably connected to the AA thermal power plant 1302, the BB hydroelectric power plant 1303, and the CC photovoltaic power plant 1304. Thus, the head office 1301 can grasp situations of the AA thermal power plant 1302, the BB hydroelectric power plant 1303, and the CC photovoltaic power plant 1304. For example, the head office 1301 can grasp the amount of electric power generated by each power generation facility, the emission amount of carbon dioxide generated by power generation, and the like.

The head office 1301 is provided with a server 1305 for providing information on the current electric power based on the situation grasped about the power generation facilities.

The server 1305 is connected to a public network to which an external device can be connected. The server 1305 discloses information on the power generation facilities owned by the electric utility company 1300. An example of information provided by the server 1305 is illustrated below. Note that the disclosed information on the power generation facilities owned by the electric utility company 1300 in the present embodiment is not limited to the information provided by the server 1305, and other information may be disclosed.

Specifically, the server 1305 provides information indicating a ratio of an amount of electric power generated by each of the AA thermal power plant 1302, the BB hydroelectric power plant 1303, and the CC photovoltaic power plant 1304 to the amount of electric power provided by the electric utility company 1300.

Further, the server 1305 provides information indicating the emission amount of carbon dioxide corresponding to the amount of electric power generated by each of the AA thermal power plant 1302, the BB hydroelectric power plant 1303, and the CC photovoltaic power plant 1304.

As illustrated in FIG. 3, the production company 1000 includes a management device 1100, a plurality of injection molding machines 10, and a crusher 15. The management device 1100, each of the plurality of injection molding machines 10, and the crusher 15 are connected to each other by a communication line.

In addition, a photovoltaic power generation facility 1060 provided for in-house power generation may be installed in the production company 1000.

The management device 1100 is used for managing molding of a molded article by the injection molding machine 10. For example, the management device 1100 manages information transmitted from the plurality of injection molding machines 10, the crusher 15, and the like.

In addition, when the photovoltaic power generation facility 1060 is provided in the production company 1000, the management device 1100 may hold information indicating the emission amount of carbon dioxide corresponding to the amount of electric power generated by the photovoltaic power generation facility 1060. The emission amount of carbon dioxide corresponding to the amount of electric power generated by the photovoltaic power generation facility 1060 is, for example, information (e.g., catalog information) provided by a company that provides the photovoltaic power generation facility 1060 to the production company 1000. The emission amount of carbon dioxide corresponding to the amount of electric power generated by the photovoltaic power generation facility 1060 may be calculated based on the emission amount of carbon dioxide required for the production of the photovoltaic power generation facility 1060 and the amount of electric power that can be generated by the predicted life of the photovoltaic power generation facility 1060. The management device 1100 may transmit information indicating the emission amount of carbon dioxide corresponding to the amount of electric power generated by the photovoltaic power generation facility 1060 to the injection molding machine 10.

The crusher 15 is used to crush runners and the like generated in molding by the injection molding machine 10.

Further, a mold temperature regulator 11, a remove robot 12, and a dryer 13 are communicably connected to each of the plurality of injection molding machines 10.

The mold temperature regulator 11 is used to regulate the temperature of the mold device 800 of the injection molding machine 10 in response to a request from the injection molding machine 10. The remove robot 12 is used to remove a molded article or the like molded by the injection molding machine 10 in response to a request from the injection molding machine 10. The dryer 13 is used to dry a molded article molded by the injection molding machine 10 in response to a request from the injection molding machine 10.

The injection molding machine 10 according to the present embodiment is configured to be able to calculate the emission amount of carbon dioxide generated by molding (an example of production) of a molded article and display the calculated emission amount.

In order to display the emission amount of carbon dioxide, it is necessary to set information indicating the ratio of the amount of electric power generated by each of the power generation facilities (AA thermal power plant 1302, BB hydroelectric power plant 1303, CC photovoltaic power plant 1304, and photovoltaic power generation facility 1060) to the amount of electric power provided by the electric utility company 1300, and information indicating the emission amount of carbon dioxide corresponding to the amount of electric power generated by each of the power generation facilities, in addition to the amount of electric power used by the injection molding machines 10.

Therefore, an operator 1050 according to the present embodiment accesses the server 1305 by a mobile communication terminal 1051 and checks information disclosed in the server 1305. Then, the operator 1050 sets information indicating the ratio of the amount of electric power generated by each of the power generation facilities (the AA thermal power plant 1302, the BB hydroelectric power plant 1303, and the CC photovoltaic power plant 1304) and information indicating the emission amount of carbon dioxide corresponding to the amount of electric power generated by each of the power generation facilities, to the injection molding machine 10, based on the information disclosed in the server 1305 and the information on the photovoltaic power generation facility 1060 provided for in-house power generation.

There is no limitation to the method of setting information used by the operator 1050 with respect to the injection molding machine 10. For example, the operator 1050 may input, to the management device 1100, information indicating the ratio of the amount of electric power generated by each of the power generation facilities (the AA thermal power plant 1302, the BB hydroelectric power plant 1303, and the CC photovoltaic power plant 1304) and information indicating the emission amount of carbon dioxide corresponding to the amount of electric power generated by each of the power generation facilities. Then, the management device 1100 transmits the input information to each of the injection molding machines 10. Accordingly, the control device 700 of the injection molding machine 10 may set information indicating the ratio of the amount of electric power generated by each of the power generation facilities (the AA thermal power plant 1302, the BB hydroelectric power plant 1303, and the CC photovoltaic power plant 1304) and information indicating the emission amount of carbon dioxide corresponding to the amount of electric power generated by each of the power generation facilities.

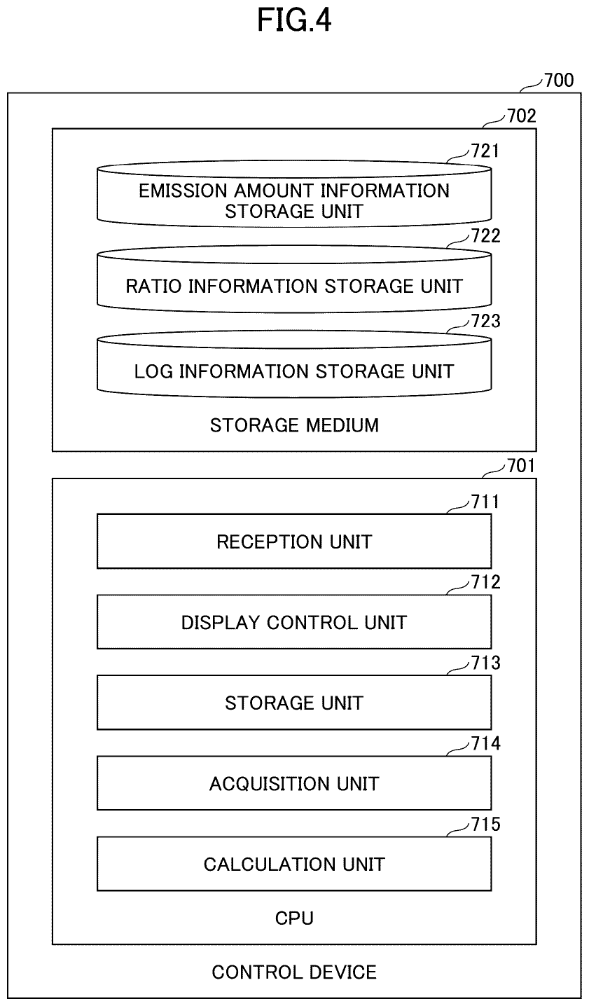

FIG. 4 is a functional block diagram illustrating components of the control device 700 of the injection molding machine 10 according to the present embodiment. Each functional block illustrated in FIG. 4 is conceptual, and is not necessarily physically configured as illustrated. All or some of the functional blocks may be configured to be functionally or physically distributed or integrated in any units. All or any part of the processing functions performed by the functional blocks of the control device 700 are implemented by a program executed in the CPU 701. Alternatively, each functional block may be implemented as hardware by wired logic. As illustrated in FIG. 4, the CPU 701 of the control device 700 includes a reception unit 711, a display control unit 712, a storage unit 713, an acquisition unit 714, and a calculation unit 715. The control device 700 includes an emission amount information storage unit 721, a ratio information storage unit 722, and a log information storage unit 723 in the storage medium 702.

The emission amount information storage unit 721 stores, for each power generation facility (the name of the power generation facility) that supplies electric power to the injection molding machine 10, emission amount information indicating an emission amount of carbon dioxide corresponding to the amount of electric power generated by a corresponding one of the power generation facilities. The emission amount information may be information transmitted from the management device 1100 or information input by the operator 1050. The emission amount information may be an emission coefficient by which the amount of electric power is multiplied to derive the emission amount, or may be any information as long as the emission amount can be derived, such as a conversion formula for deriving the emission amount of carbon dioxide.

The carbon dioxide emission amount information corresponding to the amount of electric power generated by the power generation facility of the electric utility company is information provided by the electric utility company for each power generation facility. The carbon dioxide emission amount information corresponding to the amount of electric power generated by the power generation facility provided for in-house power generation is information (e.g., catalog information) provided by the company that provides the power generation facility to the production company 1000. Since the emission information is information specifically provided for each power generation facility, a specific emission amount of carbon dioxide can be calculated.

The ratio information storage unit 722 stores ratio information indicating a ratio of the amount of electric power supplied from each of the power generation facilities for the injection molding machine 10 to mold a molded article. The ratio information may be information transmitted from the management device 1100 or information input by the operator 1050.

The log information storage unit 723 stores log information indicating actual values that are detection results by various sensors (an example of a detection unit).

The display control unit 712 performs control to display data, such as a display screen, on the touch panel 770. The display control unit 712 according to the present embodiment may output a display screen on which the actual value detected in each process of the molding process by the injection molding machine 10 is displayed for each shot to the touch panel 770. Note that, in the present embodiment, an example in which a display screen or the like is output to the touch panel 770 will be described, but the output destination of data is not limited to the touch panel 770. For example, the display control unit 712 may output data of a display screen or the like to the mobile communication terminal 1051 connected via a network.

The reception unit 711 receives an operation of the operator from the touch panel 770 via the input I/F 703.

The storage unit 713 stores various kinds of information in the storage medium 702. For example, the storage unit 713 stores the actual value during molding, the statistical value, and the like in the log information storage unit 723 as log information. The operation for storing the log information is performed on the log information screen displayed by the display control unit 712. The specific operation will be described later.

The acquisition unit 714 acquires detection results from various sensors provided in the injection molding machine 10. For example, the acquisition unit 714 acquires the amount of electric power consumed by the injection molding machine 10.

The calculation unit 715 calculates numerical values and the like to be displayed on the screen based on the actual values and the like obtained by the various sensors.

In the present embodiment, the operator 1050 may input a ratio of the amount of electric power supplied from each of the power generation facilities, which is used to calculate the emission amount of carbon dioxide. A screen for setting the ratio of the amount of electric power, which is displayed on the display device 760 according to the present embodiment, will be described.

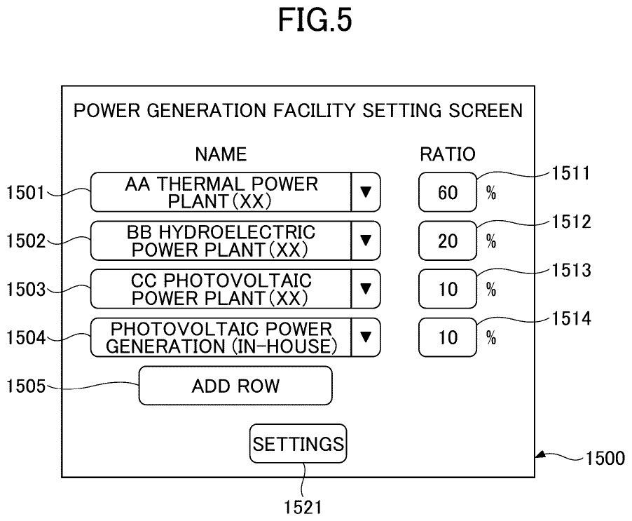

FIG. 5 is a diagram illustrating a power generation facility setting screen output by the display control unit 712 according to the present embodiment.

The power generation facility setting screen (an example of the first screen) illustrated in FIG. 5 is an example of a screen for receiving an input of information relating to a ratio of an amount of electric power supplied from each of one or more power generation facilities among the power generation facilities owned by the electric utility company 1300 that has a contract for supplying power to the injection molding machine 10 and the power generation facility (the photovoltaic power generation facility 1060) provided for in-house power generation.

The power generation facility setting screen 1500 illustrated in FIG. 5 includes name fields 1501, 1502, 1503, and 1504, ratio fields 1511, 1512, 1513, and 1514, an add row button 1505, and a settings button 1521.

In the power generation facility setting screen 1500 illustrated in FIG. 5, every time the reception unit 711 receives pressing of the add row button 1505, the display control unit 712 performs display to add one name field and one ratio field.

In the example illustrated in FIG. 5, it is assumed that the reception unit 711 receives four times of pressing of the add row button 1505. Thereafter, the reception unit 711 receives input of the names of the four power generation facilities (e.g., “AA thermal power plant (XX)”, “BB hydroelectric power plant (XX)”, “CC photovoltaic power plant (XX)”, and “photovoltaic power plant (in-house)”).

The name field according to the present embodiment is, for example, a pull-down menu, and can receive selection from the names of the power generation facilities stored in the emission amount information storage unit 721 in association with the emission amount information.

A name of a new power generation facility may be input in the name field. In this case, an emission amount of carbon dioxide corresponding to an amount of electric power in the new power generation facility is input. Thus, the storage unit 713 stores the name of the new power generation facility in association with emission amount information indicating the emission amount of carbon dioxide corresponding to the amount of electric power in the new power generation facility in the emission amount information storage unit 721.

The operator inputs a ratio of the amount of the electric power generated by each of the power generation facilities in percentage (%) in the ratio field while referring to the information provided by the server 1305. Accordingly, the reception unit 711 receives, from the ratio field, the input of the ratio of the amount of electric power supplied from each of the power generation facilities selected in the name field. This allows the ratio of the amount of electric power generated by each of the power generation facilities to be associated with the input of the ratio of the amount of electric power supplied from a corresponding one of the power generation facilities selected in the name field. Note that, in the present embodiment, an example of receiving an input of a percentage (%) is described as a method of receiving an input of a ratio, but the present disclosure is not limited to this example of receiving an input of a percentage, and any information that can be recognized may be received as an input of a ratio.

In the example illustrated in FIG. 5, the “AA thermal power plant (XX)” is set to generate “60%”, the “BB hydroelectric power plant (XX)” is set to generate “20%”, the “CC photovoltaic power plant (XX)” is set to generate “10%”, and the “photovoltaic power generation (in-house)” is set to generate “10%”.

When the reception unit 711 receives the pressing of the settings button 1521, the storage unit 713 stores the power generation facility and the ratio of the amount of electric power input for each power generation facility in the ratio information storage unit 722 in association with each other based on the input in the name field and the ratio field. This makes it possible to identify the ratio of the amount of electric power supplied from each of the power generation facilities.

As described above, the control device 700 according to the present embodiment displays the power generation facility setting screen (an example of a first screen) 1500 configured to receive input of information relating to the ratio of the amount of electric power supplied from each of the power generation facilities on the display device 760 for one or more power generation facilities among the power generation facilities owned by the electric utility company that has a contract for supplying electric power to the injection molding machine 10 and the power generation facility provided for in-house power generation. Thus, the injection molding machine 10 can grasp the ratio of the amount of electric power of each power generation facility used for molding the molded article.

In the power generation facility setting screen 1500 according to the present embodiment, an example in which a power generation facility can be selected from power generation facilities owned by XX Electric Power Corporation which is the electric utility company 1300 and a power generation facility provided for in-house power generation will be described, but the power generation facilities to be selected are not limited to these examples. For example, when the power generation facility is contracted with a plurality of electric utility companies, the power generation facility can be selected from power generation facilities owned by the plurality of electric utility companies.

Thereafter, when the injection molding machine 10 starts molding of a molded article, the acquisition unit 714 acquires the amount of electric power supplied for molding the molded article every time the molded article is molded. This makes it possible to calculate the emission amount of carbon dioxide.

When calculating the emission amount of carbon dioxide, the calculation unit 715 acquires information indicating the emission amount of carbon dioxide corresponding to the amount of electric power supplied from each of the power generation facilities from the emission amount information storage unit 721. Further, the calculation unit 715 acquires information indicating the ratio of the amount of electric power supplied from each of the power generation facilities from the ratio information storage unit 722.

Then, the calculation unit 715 calculates the emission amount of carbon dioxide generated for molding the molded article based on the amount of electric power supplied for molding the molded article in the injection molding machine 10, the information indicating the emission amount of carbon dioxide corresponding to the amount of electric power supplied from each of the power generation facilities, and the information indicating the ratio of the amount of electric power supplied from each of the power generation facilities. The calculated emission amount of carbon dioxide may be displayed on a log information screen or the like. The log information screen is a screen for displaying an actual value during molding, a statistical value, and the like.

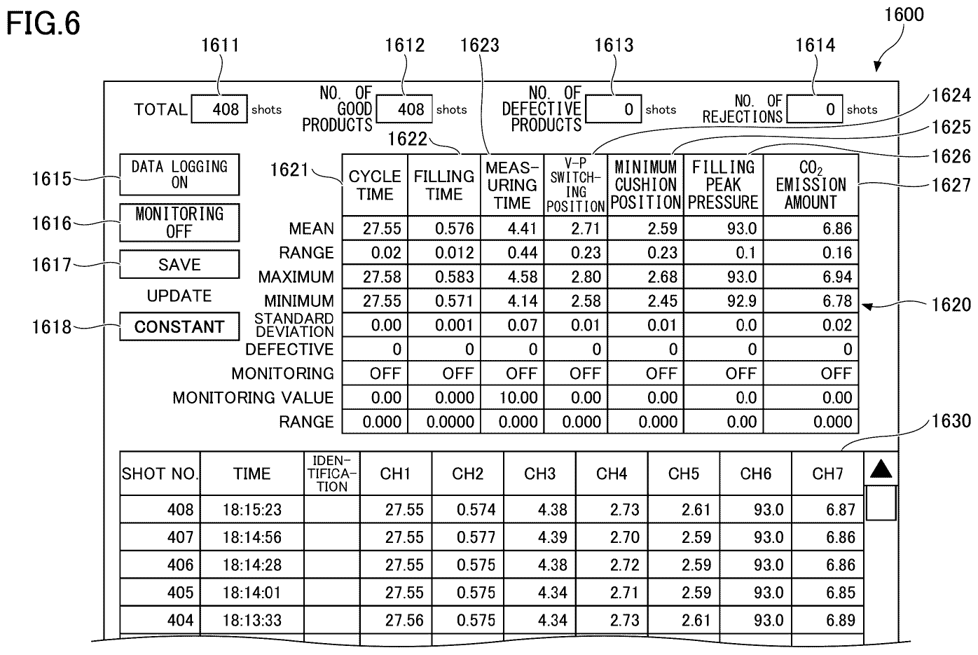

FIG. 6 is a diagram illustrating an example of a log information screen output by the display control unit 712 according to the present embodiment.

The log information screen 1600 illustrated in FIG. 6 includes a total 1611, the number of good products 1612, the number of defective products 1613, the number of rejections 1614, a logging button 1615, a monitoring settings button 1616, a save button 1617, an update button 1618, a statistics list 1620, and a result list 1630.

The statistics list 1620 illustrates statistical information (e.g., a mean, a range, a maximum, a minimum, and a standard deviation) for each of the setting fields 1621 to 1627. The contents displayed in the setting fields 1621 to 1627 can be set by the operator. In the present embodiment, items displayed in the setting fields 1621 to 1627 can be displayed, monitored, and log information can be stored. The monitoring in the present embodiment represents determination of whether a product is a non-defective product based on predetermined criteria.

The statistical information is information calculated based on the actual value (an example of a parameter) obtained every time a molded article is manufactured by performing injection molding with the injection molding machine 10, and includes, for example, a mean, a range, a maximum, a minimum, and a standard deviation calculated for each of the setting fields 1621 to 1627 in the statistics list 1620. Note that the present embodiment illustrates an example of the statistical information, and statistical information other than the mean, the range, the maximum, the minimum, and the standard deviation, for example, an integral value or the like may be used. In addition, the items for which the statistical information is calculated are not limited to the items set in the setting fields 1621 to 1627, and may be other items.

The calculation unit 715 calculates the statistical information by including the actual value (an example of the parameter) obtained in the injection molding in the range indicated in the result list 1630 as a calculation target. Then, the display control unit 712 displays the statistical information calculated by the calculation unit 715 in the statistics list 1620.

The “monitoring”, the “monitoring value”, and the “range” of the statistics list 1620 are information for determining whether the molded article in the setting field is defective.

When the monitoring of the statistics list 1620 is “OFF”, the control device 700 does not perform monitoring, and when the monitoring is “ON”, the control device 700 performs monitoring. In the case of “ON”, the control device 700 determines whether the measured actual value in the item indicated in the setting field satisfies the criteria indicated by “monitored value” and “range” (e.g., whether the measured actual value is included in “range” with “monitored value” as the median). The switching of the monitoring is performed by the monitoring settings button 1616.

The “defective” of the statistics list 1620 indicates the number of molded products that do not satisfy the criteria indicated by the “monitoring value” and the “range”.

The “cycle time” in the setting field 1621, the “filling time” in the setting field 1622, and the “measuring time” in the setting field 1623 are items set to monitor the time required for the cycle, the filling, and the measurement.

The “V-P switching position” of the setting field 1624 is an item set to monitor the position (V/P switching position) of the screw 330 when the process is switched from the filling process to the pressure holding process. The “minimum cushion position” of the setting field 1625 is an item set to monitor the position of the screw 330 when the screw moves to the forefront when applying pressure after filling the molding material into the mold device 800. The “filling peak pressure” in the setting field 1626 is an item set for monitoring the peak value of the pressure when the molding material is filled.

The “CO₂ emission amount” in the setting field 1627 is an item set to monitor the emission amount of carbon dioxide that is emitted every time a molded article is molded.

The setting fields 1621 to 1627 can be changed to items that the operator desires to monitor. The description of the changing method is omitted.

The result list 1630 represents a list of setting information (e.g., setting values) in the items set in the setting fields 1621 to 1627 or actual values measured by various sensors for each shot. The items set in the setting fields 1621 to 1627 are set from “CH1” to “CH7”. Further, for each shot, “shot number”, “time” when injection molding is performed, and “identification” of injection molding are associated as information indicating the shot.

The logging button 1615 is a button for receiving selection of whether to save the actual value illustrated in the result list 1630 as log information. When the logging button 1615 is pressed (“data logging ON” is displayed), the storage unit 713 saves information (e.g., actual values by various sensors) indicated in the result list 1630 and the like in the log information storage unit 723 as log information.

That is, in the present embodiment, the emission amount of carbon dioxide generated every time a molded article is molded can be stored as log information in the log information storage unit 723.

The monitoring settings button 1616 is a button for receiving whether to monitor according to the items to be monitored in the statistics list 1620. When the monitoring settings button 1616 is pressed (“monitoring ON” is displayed), whether a molded article is defective is monitored for each shot, and the monitoring result is included in the log information. When the monitoring settings button 1616 is pressed, monitoring for each of the setting fields 1621 to 1627 of the statistics list 1620 can be switched to “OFF” or “ON”.

The save button 1617 is a button for receiving whether to save the statistical value (e.g., mean, range, maximum, minimum, standard deviation, or the like) for each of the setting fields 1621 to 1627. When the save button 1617 is pressed, the storage unit 713 saves the statistical value for each of the setting fields 1621 to 1627 and the actual value indicated in the result list 1630 in the log information storage unit 723 as log information. In the present embodiment, an example of storing the statistical value and the actual value will be described, but the embodiment of the present disclosure is not limited to the storage of the statistical value and the actual value. For example, when a setting value is indicated in the result list 1630, the storage unit 713 may also save the setting value together with the statistical value and the actual value. Furthermore, even when the setting value is not indicated in the result list 1630, the storage unit 713 may save the setting value in association with the actual result value indicated in the result list 1630.

The update button 1618 is a button for receiving whether to update the statistics list 1620 and the result list 1630 every time injection molding by the injection molding machine 10 is completed. When the update button 1618 is pressed (“constant” is displayed), the statistics list 1620 and the result list 1630 are updated every time injection molding by the injection molding machine 10 is completed.

The total 1611 indicates the number of molded products molded by the injection molding machine 10. The number of good products 1612 indicates the number of molded products determined to be good products based on the “monitoring”, the “monitoring value”, and the “range”. The number of defective products 1613 indicates the number of molded products determined to be defective based on the “monitoring”, the “monitoring value”, and the “range”. The number of rejections 1614 indicates the number of rejected molded products.

As described above, when a plurality of molded articles are produced from a molding material by the injection molding machine 10 (an example of a production device), the display control unit 712 of the control device 700 displays, for each molded article, the actual values (examples of detection results) detected by various sensors in a process of producing the molded article in the result list 1630 of the display device 760.

In the result list 1630, “CH7” corresponds to a “CO₂ emission amount”. That is, in the column of “CH7” of the result list 1630, the calculation result of the carbon dioxide emission amount calculated by the calculation unit 715 is displayed as the record value for each shot.

Thus, the operator 1050 can monitor the emission amount of carbon dioxide generated every time a molded article is molded.

Further, when the logging button 1615 is pressed, the storage unit 713 saves information (e.g., actual values by various sensors) indicated in the result list 1630 in the log information storage unit 723 as log information, and thus the emission amount of carbon dioxide generated every time a molded article is molded is saved in the log information storage unit 723 as log information. Therefore, the emission amount of carbon dioxide generated when molding a molded article can be managed for each molded article.

In the present embodiment, the log information including the emission amount of carbon dioxide is stored in the log information storage unit 723 via the storage performed by the storage unit 713. The emission amount of carbon dioxide stored as the log information may be displayed on another screen.

In the present embodiment, the log information screen (an example of a second screen) 1600 has been described as a screen for displaying the calculation result of the carbon dioxide emission amount generated by molding of the molded article by the injection molding machine 10. However, in the present embodiment, the screen for displaying the calculation result of the carbon dioxide emission amount is not limited to the log information screen 1600, and any screen may be used as long as the calculation result of the emission amount of carbon dioxide can be displayed.

For example, the carbon dioxide emission amount may be displayed on the screen in units of lots for molding the molded article, instead of being displayed in units of molded articles.

In the present embodiment, the carbon dioxide emission amount per molded article calculated by the calculation unit 715 is not limited to that based on the amount of electric power consumed by the injection molding machine 10, and may include the amount of electric power consumed by an external device used for molding the molded article other than the injection molding machine 10.

For example, the acquisition unit 714 of the control device 700 may acquire the amount of electric power used for the adjustment of the temperature of the mold device 800 from the mold temperature regulator 11 via the communication I/F 705. The acquisition unit 714 of the control device 700 may acquire the amount of electric power used for taking out the molded article or the like from the remove robot 12 via the communication I/F 705. Further, the acquisition unit 714 of the control device 700 may acquire the amount of electric power required for drying the molded article from the dryer 13 via the communication I/F 705.

Further, the acquisition unit 714 of the control device 700 may acquire the amount of electric power required for crushing the runner or the like generated every time the molded product is molded from the crusher 15.

Then, when the amount of electric power consumed by the external device is acquired, the calculation unit 715 may calculate the emission amount of carbon dioxide corresponding to the amount of electric power consumed by the external device every time the molded article is molded, based on the amount of electric power consumed by the external device. When the external device is used across a plurality of shots, the calculation unit 715 may perform calculation so that the emission amount of carbon dioxide corresponding to the amount of electric power consumed by the external device is equally divided into the plurality of shots, or may allocate the emission amount of carbon dioxide to each shot by a predetermined method.

The storage unit 713 may store the emission amount of carbon dioxide generated due to the use of the external device for each molded article as log information. In addition, when the power is consumed by the external device while the molded article is not molded, the acquisition unit 714 may acquire the amount of electric power consumed by the external device, and the storage unit 713 may store the acquired amount of electric power as the log information. Further, the emission amount of carbon dioxide generated by the use of the external device may be displayed on the screen.

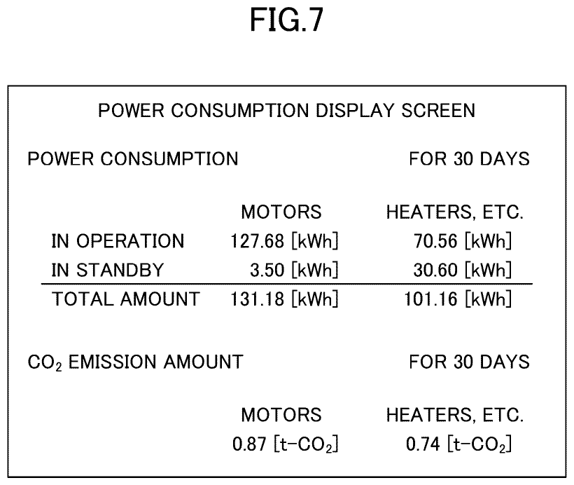

FIG. 7 is a diagram illustrating a power consumption display screen output by the display control unit 712 according to the present embodiment. The power consumption display screen illustrated in FIG. 7 displays the power consumption for 30 days and the carbon dioxide emission amount for 30 days. The power consumption illustrated in FIG. 7 represents the power consumption of the injection molding machine 10 in operation and the power consumption of the injection molding machine 10 in standby.

Specifically, the motor column illustrates the power consumption of various motors of the injection molding machine 10 in operation and the power consumption of various motors of the injection molding machine 10 in standby. The heater column illustrates the total power consumption of the external devices (the mold temperature regulator 11, the remove robot 12, the dryer 13, and the crusher 15) when the injection molding machine 10 is in operation, and the total power consumption of the external devices when the injection molding machine 10 is in standby.

The CO₂ emission amount illustrated in FIG. 7 is illustrated in the motor column and the heater column. The motor column illustrates the emission amount of carbon dioxide discharged from each motor of the injection molding machine 10. The heater column indicates the emission amount of carbon dioxide discharged from an external device of the injection molding machine 10. The emission amount of carbon dioxide indicated in each of the motor column and the heater column is a total amount of the emission amount of carbon dioxide of the injection molding machine 10 in operation and the emission amount of carbon dioxide of the injection molding machine 10 in standby, but may be indicated separately in standby and in operation, similarly to the power consumption.

In the present embodiment, an example in which the control device 700 of the injection molding machine 10 calculates the emission amount of carbon dioxide and stores the emission amount as log information has been described. However, the present embodiment is not limited to an example in which the control device 700 of the injection molding machine 10 functions as a production management device that calculates and manages the emission amount of carbon dioxide discharged.

For example, the management device 1100 may have the same configuration as the control device 700 described above, and may calculate the emission amount of carbon dioxide discharged for each injection molding machine 10 by receiving information relating to the amount of electric power used every time a molded article is molded from the injection molding machine 10, and may store the emission amount of carbon dioxide discharged in a storage medium (not illustrated). Further, the management device 1100 may display the emission amount of carbon dioxide. A specific method may be the same as the above-described method, and thus the description thereof will be omitted.

As described above, the production management device that calculates and manages the emission amount of carbon dioxide may be provided in the injection molding machine 10 or may be provided as an external device of the injection molding machine 10.

The calculation result of the emission amount of carbon dioxide is not limited to the form of being displayed on the display device 760 of the injection molding machine 10. For example, the control device 700 of the injection molding machine 10 may calculate the emission amount of carbon dioxide and transmit the calculation result of the emission amount of carbon dioxide to the mobile communication terminal 1051 or the management device 1100. Accordingly, the mobile communication terminal 1051 or the management device 1100 may display the calculation result of the emission amount of carbon dioxide.

### Another Embodiment

In the embodiment, an example in which the operator inputs information relating to the ratio to the power generation facility setting screen or the like has been described. However, the above-described embodiment is not limited to the example in which the operator inputs the information relating to the ratio to the power generation facility setting screen or the like. In another embodiment, an example in which the server 1305 provides information on the power generation facility to the management device 1100 will be described.

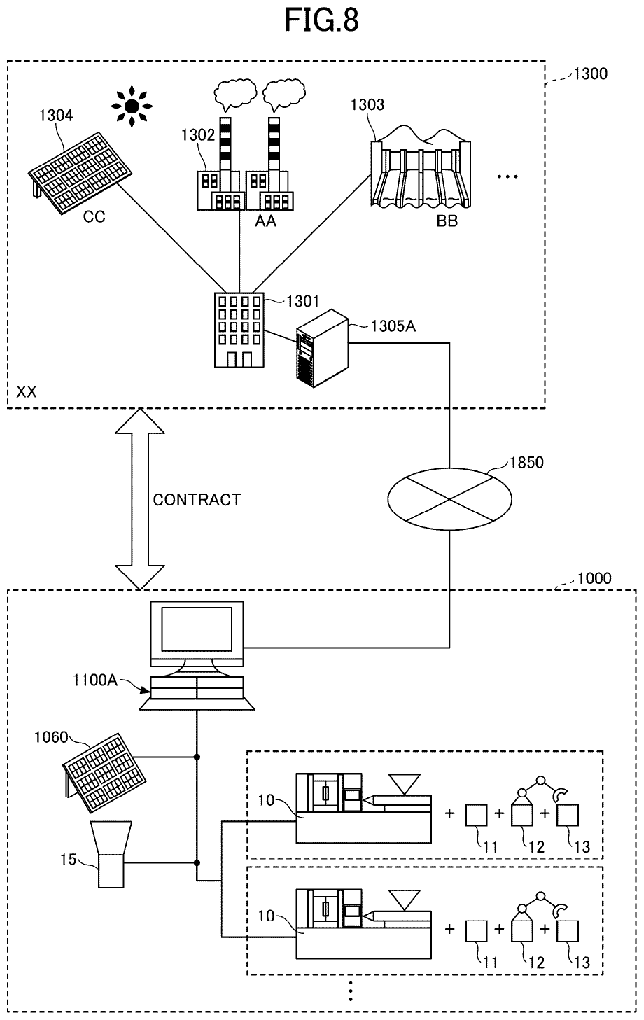

FIG. 8 is a conceptual diagram illustrating a relationship between a production company 1000 having a production device and an electric utility company 1300 for supplying electric power according to another embodiment. In the conceptual diagram illustrated in FIG. 8, the same components as those in FIG. 3 are denoted by the same reference numerals, and the description thereof will be omitted.

In the example illustrated in FIG. 8, a server 1305A for providing information on the current electric power is provided in the head office 1301 as the electric utility company 1300.

The server 1305A is connected to a public network 1850. The server 1305 transmits information on the power plants owned by the electric utility company 1300 via the public network 1850.

For example, the server 1305A transmits emission information indicating the emission amount of carbon dioxide corresponding to the amount of electric power generated by each of the AA thermal power plant 1302, the BB hydroelectric power plant 1303, and the CC photovoltaic power plant 1304 to an external device (e.g., a management device 1100A) connected via the public network 1850.

Further, the server 1305A transmits ratio information indicating a ratio of the amount of electric power generated by each of the AA thermal power plant 1302, the BB hydroelectric power plant 1303, and the CC photovoltaic power plant 1304 to the external device (e.g., the management device 1100A) connected via the public network 1850.

The server 1305A may transmit the information indicating the ratio of the amount of electric power at the timing when the ratio of the amount of electric power is changed. For example, when the amount of electric power generated by the CC photovoltaic power plant 1304 changes due to a weather change, the server 1305A may transmit information indicating the ratios of the amount of electric power in consideration of the change in the amount of electric power generated by the CC photovoltaic power plant 1304.

In the example illustrated in FIG. 8, the production company 1000 includes the management device 1100A.

The management device 1100A receives the information from the server 1305A via the public network 1850.

For example, when the management device 1100A receives emission information indicating the emission amount of carbon dioxide corresponding to the amount of electric power generated by each of the AA thermal power plant 1302, the BB hydroelectric power plant 1303, and the CC photovoltaic power plant 1304 from the server 1305A, the management device 1100A transmits the corresponding emission information to the injection molding machine 10.

The control device 700 of the injection molding machine 10 receives the emission information indicating the emission amount of carbon dioxide corresponding to the amount of electric power generated by each power generation facility from the management device (an example of an information processing device) 1100A via the communication I/F (an example of a communication unit) 705. Then, the storage unit 713 saves the received emission information in the emission amount information storage unit 721.

After receiving the emission information, the calculation unit 715 performs switching to calculate the emission amount of carbon dioxide generated by the molding of the molded article of the injection molding machine 10 based on the emission information stored in the emission amount information storage unit 721.

As another example, when the management device 1100A receives the ratio information from the server 1305A, the management device 1100A derives ratio information indicating a ratio of the amount of electric power generated by each of the power generation facilities including the photovoltaic power generation facility 1060 in consideration of the amount of electric power generated by the photovoltaic power generation facility 1060 provided for in-house power generation, and transmits the derived ratio information to the injection molding machine 10.

The control device 700 of the injection molding machine 10 receives ratio information indicating the ratio of the amount of electric power generated by each of the power generation facilities from the management device 1100A via the communication I/F (an example of a communication unit) 705. The storage unit 713 saves the received ratio information in the ratio information storage unit 722.

After receiving the ratio information, the calculation unit 715 performs switching to calculate the emission amount of carbon dioxide generated by the molding of the molded article of the injection molding machine 10 based on the ratio information stored in the ratio information storage unit 722.

In the present embodiment, when the ratios of the amounts of electric power generated by the power generation facilities change, the emission amount of carbon dioxide can be calculated according to the change by performing the control described above. Therefore, the calculation accuracy of the emission amount of carbon dioxide can be improved.

Further, one or more of the emission information or the ratio information described above is not limited to being managed by the injection molding machine 10. For example, one or more of the emission information or the ratio information may be managed by the management device 1100A. Then, the control device 700 may acquire (receive) one or more of the emission information or the ratio information from the management device 1100A at the timing of calculating the carbon dioxide emission amount.

In the present embodiment, the emission amount of carbon dioxide is not limited to being calculated based on the information stored in the storage medium 702 and being managed by the control device 700, and the emission amount of carbon dioxide may be calculated and managed by an external system. As the external system, a cloud service, a manufacturing execution system, or a quality control system that implements emission calculation based on the GHG protocol of the international emission calculation standard or the PCAF (Partnership for Carbon Accounting Financials) may be caused to function as the production management device.

Further, the injection molding machine 10 calculates the emission amount of carbon dioxide, but an external system may manage one or more of the emission information or the ratio information. In this case, the control device 700 of the injection molding machine 10 receives one or more of the emission information or the ratio information from the external system when calculating the emission amount of carbon dioxide.

Similarly, when the management device 1100A calculates the emission amount of carbon dioxide, the external system may manage one or more of the emission information or the ratio information. In this case, the management device 1100A receives one or more of the emission information or the ratio information from the external system when calculating the emission amount of carbon dioxide.

### Functional Effect

In the above-described embodiment, when the injection molding machine 10 molds a molded article, the production management device such as the control device 700 calculates an emission amount of carbon dioxide generated by the production of a product in consideration of the emission amount of carbon dioxide generated by power generation of one or more of the power generation facilities owned by the electric utility company and the power generation facility provided for in-house power generation, thereby making it possible for an operator or user to grasp the situation regarding the production of the product. That is, the emission amount of carbon dioxide discharged during molding of a molded article by the injection molding machine 10 can be visualized. Therefore, the production companies will be able to publicly announce their efforts to realize a low-carbon society, etc.

In the above-described embodiments, the case where the production device for managing the emission amount of carbon dioxide is the injection molding machine has been described. However, in the above-described embodiment, the production device, which is a target for managing the emission amount of carbon dioxide, is not limited to the injection molding machine, and may be applied to, for example, an extrusion molding machine, a blow molding machine, or the like. Further, the present disclosure is not limited to the device for molding a product by processing plastic or the like, and may be applied to a device for producing a product by processing metal or the like. That is, any production device capable of mass-producing products using any material such as plastic or metal can be used for the control described in the above embodiments.

Although the embodiments of the production management device, the display device, and the production device according to the present disclosure have been described above, the present disclosure is not limited to the above-described embodiments and the like. Various changes, modifications, substitutions, additions, deletions, and combinations are possible within the scope of the claims. Such modifications are also included in the technical scope of the present disclosure.

What is claimed is:

1. A production management device comprising:
circuitry configured to
acquire information indicating an emission amount of carbon dioxide corresponding to an amount of electric power supplied from each of one or more of power generation facilities, among power generation facilities owned by an electric utility company that has a contract for supplying electric power to a production device and a power generation facility provided for in-house power generation;
acquire information indicating a ratio of the amount of electric power supplied from a corresponding one of the one or more of the power generation facilities for the production device to produce a product; and
calculate an emission amount of carbon dioxide generated by the production of the product, based on an amount of electric power used for the production of the product, the ratios of the amounts of electric power supplied from the one or more of the power generation facilities, and emission amounts of carbon dioxide corresponding to the amounts of electric power generated by the one or more of the power generation facilities.

2. The production management device according to claim 1, wherein the circuitry acquires an amount of electric power consumed by an external device used other than the production device while the product is produced, and calculates the emission amount of carbon dioxide generated by the production of the product further using the amount of electric power consumed by the external device.

3. The production management device according to claim 1, wherein the emission amounts of carbon dioxide corresponding to the amounts of electric power generated by the one or more of the power generation facilities are based on one or more of information provided by a company that has produced the power generation facility provided for in-house power generation and information provided by the electric utility company for the one or more of the power generation facilities owned by the electric utility company.

4. The production management device according to claim 1, wherein the circuitry receives an input of information relating to each of the ratios of the amounts of electric power supplied from the one or more of the power generation facilities, and specifies a corresponding one of the ratios of the amounts of electric power supplied from the one of the one or more of the power generation facilities, based on the received input of the information.

5. The production management device according to claim 1, wherein the circuitry is further configured to communicate with an information processing device provided by the electric utility company, and wherein
the circuitry receives information indicating emission amounts of carbon dioxide corresponding to amounts of electric power generated by the power generation facilities provided by the electric utility company from the information processing device via the communication unit, and
the circuitry performs switching, upon receiving the information indicating the emission amounts of carbon dioxide corresponding to the amounts of electric power, to calculate the emission amount of carbon dioxide generated by production of the product, based on the received information.

6. The production management device according to claim 1, wherein the circuitry is further configured to communicate with an information processing device provided by the electric utility company, and wherein
the circuitry receives information indicating ratios of amounts of electric power generated by the power generation facilities owned by the electric utility company from the information processing device via the communication unit, and
the circuitry performs switching, upon receiving the information indicating the ratios of the amounts of electric power, to calculate the emission amount of carbon dioxide generated by the production of the product, based on the received information.

7. A display device comprising:
a display unit configured to
display a first screen configured to receive an input of information relating to a ratio of an amount of electric power supplied from each of one or more power generation facilities, among power generation facilities owned by an electric utility company that has a contract for supplying electric power to a production device and a power generation facility provided for in-house power generation; and
display, as a second screen, a calculation result of an emission amount of carbon dioxide generated by production of a product, based on an amount of electric power used for the production device to produce the product, information indicating emission amounts of carbon dioxide corresponding to the amounts of electric power generated by the one or more of the power generation facilities, and the information indicating the ratios of the amounts of electric power received from the first screen.

8. A production device for producing a product, the production device comprising:
circuitry configured to
acquire information indicating an emission amount of carbon dioxide corresponding to an amount of electric power supplied from each of one or more of power generation facilities, among power generation facilities owned by an electric utility company that has a contract for supplying electric power to a production device and a power generation facility provided for in-house power generation;
acquire information indicating a ratio of the amount of electric power supplied from a corresponding one of the one or more of the power generation facilities for the production device to produce a product; and
calculate an emission amount of carbon dioxide generated by the production of the product, based on an amount of electric power used for the production of the product, the ratios of the amounts of electric power supplied from the one or more of the power generation facilities, and emission amounts of carbon dioxide corresponding to the amounts of electric power generated by the one or more of the power generation facilities.
